(19) United States
(12) Patent Application Publication
(10) Pub. No.: US 2008/0060084 A1
(43) Pub. Date: Mar. 6, 2008

(54) DISTRIBUTION AND MANAGEMENT OF CONTENT USING PLAYLISTS

(75) Inventors: David A. Gappa, Gobles, MI (US); Wendy Young, Schwenksville, PA (US); Russell J. Brooks, Wales, PA (US); Raymond J. Baranoski, Bensalem, PA (US); Peter J. Blowers, Otsego, MI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Library Video Company

(21) Appl. No.: 11/771,745

(22) Filed: Jun. 29, 2007

Related U.S. Application Data
(60) Provisional application No. 60/817,395, filed on Jun. 30, 2006.
(60) Provisional application No. 60/905,027, filed on Mar. 6, 2007.

(51) Int. Cl. H04L 9/32; G06F 17/30; G06F 9/46

(52) U.S. Cl. 726/28; 707/3; 718/102

(57) ABSTRACT

The present invention provides systems, apparatuses and methods that can manage the distribution of items such as playlists. The present invention also provides for controlling the Digital Rights Management (DRM) of licensed items provided to each remote location without the need for local servers at each remote location. The present invention can also manage the uploading and publishing of items created at a remote location for distribution to other remote locations. Further, the present invention effectively manages creation and presentation of playlists based on the digital access rights of playlist users.

### RELATED APPLICATIONS

This application claims priority to U.S. Provisional Application No. 60/817,395, filed Jun. 30, 2006, and U.S. Provisional Application No. 60/905,027, filed Mar. 6, 2007, each of which is hereby incorporated by reference in its entirety.

### FIELD OF THE INVENTION

The present invention generally relates to the distribution of digital content and in particular to the management of digital rights using playlists.

### BACKGROUND OF THE INVENTION

Certain known systems manage rights to electronically distributed content solely by means of information embedded or attached to the content itself. As used herein, the term “content” is meant to encompass all forms of information, including, without limitation, text, video, audio, animation, graphics, data stored in databases and other data repositories, the contents of responses to database queries, etc. “Rights” include the right to use or otherwise to take any action with respect to content, e.g., access (read, play, etc.), copy, distribute, make a derivative work, sell, purchase, etc. A limitation of such known systems is that a copy of the content must be acquired to assess the rights that accompany it. Another limitation is that the content itself (e.g., the rights management part of the content) needs to be altered to modify the associated rights. What is needed is a way to effectively and efficiently manage the rights associated with content without having to obtain or modify the content itself.

### BRIEF DESCRIPTION OF THE DRAWINGS

The accompanying drawings illustrate the present invention and, together with the description, further serve to explain the principles of the invention and to enable one skilled in the pertinent art to make and use the invention. The drawings are meant to illustrate, and not to limit, the scope of the invention. One of skill in the art will understand that the claims encompass other embodiments besides those illustrated in the drawings.

FIG. 1 illustrates a system for distributing and managing content between a central server and multiple remote units according to an aspect of the present invention.

FIG. 2 illustrates a method for dynamically presenting a playlist to a recipient in accordance with an aspect of the present invention.

FIG. 3 illustrates a method for distributing a item in accordance with an aspect of the present invention.

### DETAILED DESCRIPTION OF THE INVENTION

Embodiments of the present invention can efficiently and effectively manage the rights associated with a piece of content using playlists. A playlist is a sequence of references to one or more pieces of content. Such references can be, e.g., hyperlinks, pointers, textual references, icons, etc. Embodiments of the present invention an manage the uploading and publishing of content created at a remote location for distribution to other remote locations.

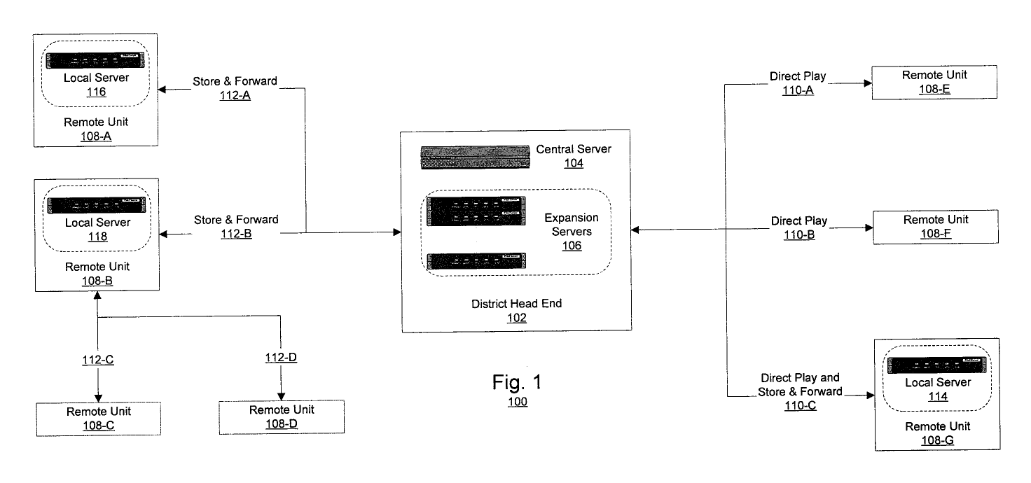

FIG. 1 illustrates a system 100 for distributing and managing content in a school district. The system can include a District Head End 102, e.g., at district headquarters, that can house a central server 104. The District Head End 102 can function as a repository of content that can be distributed to schools and end users. Accordingly, distribution processes and permission setting processes can be managed at the District Head End 102. The District Head End 102 can also include one or more expansion servers 106. The District Head End 102 can be connected to a number of remote units 108-A through 108-G (each of which can be a school) over various communication links. Each remote unit 108 can include a number of remote end units or user terminals connected to a Local Area Network (LAN).

The District Head End 102 can be connected to a remote unit (e.g., district school) 108 over a high bandwidth or a low bandwidth communication link. For example, communications links 110-A through 110-C can be relatively high bandwidth communication links (e.g., approximately 1 Gbps links) and communication links 112-A through 112-D can be relatively lower bandwidth communication links (e.g., T1 links, approximately 1.544 Mbps). Remote units 108-E and 108-F can be considered direct play remote units as these units are directly connected to the central server 104. The high bandwidth connections 110-A and 110-B allow the central server to immediately distribute video to the remote units 108-E and 108-F, respectively, when requested to do so.

Remote unit 108-G can access the central server 104 directly and/or can take advantage of the store and forward capabilities of a local server 114 physically located within the remote unit 108-G. The store and forward capabilities of the local server 114 can allow video downloaded from the central server 104 to be stored for distribution on the LAN of the remote unit 108-G. This can allow an end user of remote unit 108-G to locally retrieve video (if it has been previously stored on the local server 114) instead of retrieving the video from the central server 104.

Remote units 108-A and 108-B can be capable of exploiting direct play capabilities of the central server 104. However, due to the limited bandwidth capabilities of the communication links 112-A and 112-B, local servers 116 and 118 may be used as store and forward devices to more efficiently manage limited bandwidth. With store and forward, video requested by an end user can be distributed at a later time based on such factors as immediately available bandwidth (i.e., download video when bandwidth is available), queuing, a specified scheduled download process (e.g., overnight download or low traffic time download) or any combination thereof.

Remote units 108-C and 108-D can be considered virtual schools, e.g., schools associated with each remote unit. These virtual schools can be connected to the local server 118. Content requested by an end user at either of the virtual schools can be downloaded and stored on the local server 118. Content that is stored on the local server 118 may be accessible to a particular virtual school without being accessible to other virtual schools connected to the local server 118. That is, content stored on server 118, after download from central server 104, may be accessible to a designated set of end users at virtual school 108-D but inaccessible to a set of end users located at virtual school 108-C. Accordingly, access to content can be managed on a school-by-school basis and by an individual or group basis within each individual school using management functions and capabilities available at the central server 104.

Licensed content can be loaded onto the central server 104 for distribution to authorized remote schools 108. Further, video generated at a remote school 108 can be stored on the central server 104 for use by other users located at different remote schools 108. Locally generated video can be approved and managed by central server 104 management processes in the same manner as content that is licensed from other sources. Locally generated video can include, but is not limited to, playlists (e.g., pointers to a sequence of instructional content (such as audio and video clips) stored on the central server 104 or a local server) generated by a teacher at remote location, student created video, and recorded video (e.g., broadcast video recorded at a remote school 108).

The present invention can support school districts that use low bandwidth, high bandwidth, or hybrid communication links to interconnect its district schools. The present invention can also provide load balancing using the expansion servers 106 to optimize performance of the Wide Area Network (WAN) connecting the school district together. Overall, the present invention can provide the ability to control and preserve Internet bandwidth between all interconnections, ensure that teachers and students can access content that is appropriate and licensed for them, enable district created media to be delivered to all district schools, and provide a content-on-demand network that is readily accessible by everyone in the district using a common user interface. Further, the present invention can allow all local servers to be managed from the central server, thereby reducing administrative and/or maintenance costs. Content can also be managed more effectively from a single central repository and management location.

A central server graphical user interface configuration screen can show a list of content packages that have been loaded on the central server. This screen can allow an administrator who is authorized to administer access rights to content, to assign various rights to a selected content package. For example, the administrator can then select or otherwise specify one or more schools to whom the package is to be distributed or who should have the right to obtain and use copies of the package. The administrator can similarly assign rights to the package to one or more individuals, e.g., to one or more teachers, one or more students, one or more school administration officials, etc. Such rights may be assigned in any suitable way, e.g., by grade levels, class identifiers, school locations, etc. Any suitable restrictions on the rights can be specified by the administrator, e.g., the administrator can place limits on how many copies of the content may be used at any one time; the time of day they may be accessed, the number of copies that may be redistributed by end users, etc.

The authorized content can then be accessed in any suitable way in accordance with the controls specified by the administrator, e.g., it can be obtained and/or viewed directly from the central server or from a local server to which the content has been sent as an intermediate step.

An embodiment of the invention can also provide an auto play feature accessible through the user interface. An administrator can designate a video at the central server to broadcast to all end users or to certain end users defined by a list or by given criteria (e.g., all third grade students in school #32, all teachers in district science departments, etc.) When a user within the designated set of end users logs into the central server and selects an indicator on the user interface, the designated video can be automatically rendered to the user. The video can be shown once per user and can then be deactivated, e.g., be made unavailable for replay. Alternatively, the user interface can list the last few (e.g., 5) auto play videos (e.g., daily school news segments/broadcasts, special messages from school administrators, school alerts, etc.) from which the user can select various entries to replay.

The present invention can provide the ability to automatically transfer a user-created video from a local server to the central server. A single user entry (e.g., a mouse or keyboard click) can transfer all of the information associated with the user-created video (i.e., upload) to the central server. The administrative authority can grant the right to upload content to an individual or to a group. Published videos can reside on the central server (or, for example, on a content repository) and can be made available to other remote units/schools. The user-created video can be managed by management functions available on the central server. That is, an administrator can have the ability to approve and post or publish the user-created video. Alternatively, the administrator can disapprove and remove or delete the video. Under either scenario, an email notification or other message (e.g., SMS) can be automatically sent to the creator of the video specifying whether or not the video was accepted for publishing and the reasons for the decision.

The creator of the video can include data or information (e.g., metadata) describing the video. For example, the creator may identify the intended audience by grade level or a topic or lesson plan to which the video relates. An administrator may, in certain situations, associate rights with the uploaded content that are consistent with the identified intended audience, or may modify such rights. Alternatively, the identified audience information may be enforced automatically by the rights management system of the central server. In certain known video creation systems, operations at the central server are necessary to upload the video to the central server for review and distribution. The present invention can obviate this need by allowing the creator to upload such videos to the central server for review with a single user input command.

Published content can be housed temporarily on the local server until the administrator approves the content for distribution. Once approved, the local server can upload the items to the central server in a manner similar to which the local server handles downloads from the central server. Once the content is uploaded to the central server, each school within a system can view the approved content in accordance with the rights associated with the content.

The administrator can review the user-created content in different ways. The administrator can review metadata that can be associated with the user-created video (e.g., copyright information, author information, intended audience, etc.). The administrator can also review the content in its entirety, or a portion thereof. The administrator can review the user-created content from storage on the local server or can be “pulled” up to the central server for temporary use during the review period. The administrator can block or delete the content if the administrator does not approve the content for distribution and/or availability.

The present invention can provide the ability to create/manage and distribute video to (and receive video from) multiple schools that share one local server. The administrator can assign rights to content on a per school basis. For example, the administrator can assign each content package to all, none or some of the schools that share the local server. For example, if 10 schools share a local server, the administrative authority may allow only 5 of those schools to view a specific content package. Further, each school can have its own set of users and the administrative authority can further designate access rights on a per user, type of user or group of users basis. For example, a video can be made available to all 11^{th} graders who attend each school in the district but can be made unavailable to any other students in any other grades at any school.

Playlists can be generated by users such as teachers, students and authorized third parties. For example, teachers can tailor playlists to lesson plans, students can create playlists to create presentations on assigned topics, etc. The playlists can include multiple pointers to different content, such as videos and/or video clips, audio segments, web pages, etc. The playlists can allow users to easily view multiple content elements in succession. Since the playlist can comprise a group of different content elements, it can obviate the need for a user to search and separately retrieve and assemble a group of content elements that relate to a theme in a cogent way.

Users can set rights to a playlist in a number of ways. For example, a secret playlist may only be accessed by the creator, a shared playlist may only be accessed by users attached to the local server on which the playlist resides, a globally shared playlist may be distributed throughout the system, etc.

Playlists can be temporarily stored on the central server until the administrator approves or creates the rights associated with the playlist, e.g., distribution, viewing, copying, making derivative works, and other rights that can be associated with the playlist, such as limiting the number of times a playlist can be “played” by a single user. A playlist itself can have associated rights. Similarly, the content elements to which a playlist points can have associated rights. Rights to the content elements pointed to in a playlist can be managed and enforced at the playlist level, at the content element level, or both.

An embodiment of the present invention can provide an improved estimate for how long it will take to download items from the central server based on, but not limited to, recent history, speed of the connection, and time windows.

An embodiment of the present invention can include a search engine that can identify the providers of content that is identified as the result of a search. For example, a search for “elephants” may return a list of video clips, audio clips, web pages, documents, photographs, graphics, etc. Each individual element of the returned result can be associated with an icon representative of the creator, owner or provider of that element. For example, a video clip may have a National Geographic icon next to it, while a photograph may have a Reuters icon. These icons can be used to further sort search results, e.g., to show only results from a provider corresponding to an icon selected by the user.

The present invention can enable each remote machine/server associated with the central server to collect usage data related to its stored content packages. This information can then be periodically passed to the central server and reviewed. An administrator associated with the central server can then see a correlated report of all usage within the system. In this way, usage statistics for a particular video or playlist can be generated, e.g., on a per school, per class, per user, etc., basis.

The present invention can include syncotoparent software that focuses on communications between a remote machine and the central server. This can use a basic HTML Post of XML documents to the central server, which can parse the XML documents and update its database. The central server can respond with HTTP links to XML documents that can be passed to the remote machine. The remote machine then can perform a HTTP Get of the XML documents and can parse them and update its database.

The present invention can enable various commands, such as insert/update/delete commands to specific tables in various databases, to be triggers for tracking. Once a trigger is registered or detected, each triggering or subsequent command can be stored in a special table to keep track of the changes.

Two pointers can be kept or stored in a tracking table to determine what data to pass between machines. Both can be on the remote machines. The first can determine the position of the last record received from the central server database. This can be sent to the central server and used to query the central server database for all records past that position. The central server can send these records to the remote machine. The second pointer can determine the position of the last record added to the local database. This can be used to track playlist changes on the local machine. The local machine can use this position to query the database for the most recent playlist changes that have yet to be passed to the central server and then pass them to the central server.

Files downloaded to a remote unit/school from the central server can be safeguarded during the downloading processes. For example, the downloaded files can be encrypted, e.g., using SSL. Servicing of requests for download can be handled by the central server as HTTP requests. A link can be provided to the requester that can be comprised of a random directory structure. In this way, each request to download the same file may generate a different link to the file. After download, the link can be erased and the file can be once again hidden by the central server. In this way, content can be protected from unauthorized access.

The steps of transfer process can be viewed in any suitable way, such as: (a) each item that needs to be transferred from the central server to the remote server can be stored in a queue on the remote server; (b) the remote server can then query the database queue for the next item to download; (c) the remote server can then send a request to the central server for the file; (d) the central server can create a link to the file requested and can return a path (e.g., a randomly generated path) to the file; (e) the remote server can then implement an HTTP request for the file and can subsequently store the file locally; and (f) the remote server can then store the transaction information and re-calculate the estimated time for downloading each of the remaining queued items.

Expansion servers can be used to complement the operations of the main central server. Expansion drives can increase the number of content drives and enables the central server to offload processing to an expansion drive. Load balancing can be used to maximize throughput in a varied bandwidth environment.

In accordance with an embodiment of the present invention, playlists can be dynamically presented to recipients based on the digital access rights assigned to or otherwise associated with various users, groups of users, types of users, locations, times, dates, number of permitted views, etc. As previously mentioned, these rights can be determined and/or managed by a central administrator. Access rights can vary across different predefined groups of individuals or can vary between individuals within any particular group. Additionally, the publisher or creator of a playlist may be able to set access rights to a created playlist or to the underlying content of the playlist. Overall, the presentation of a playlist to a user can depend on these established access rights. For example, the portion of a playlist that refers to content that a user is not authorized to receive or access can be altered or displayed differently relative to the portion of a playlist that refers to content that the user is authorized to receive and access. Such alteration can be used to distinguish active references (e.g., links, pointers, etc.) to content (authorized content) from inactive references to content (restricted content). For example, active references can appear in one font on a playlist (e.g., bold) while inactive references can appear in another, e.g., italicized, grayed-out.

The presentation of active and inactive references can take on a number of forms. For example, the playlist can be configured to list references to authorized content only and not to include references to unauthorized content. Under this scenario, the playlist presented to the user only includes references to authorized content. The playlist, however, can be configured to indicate to the user that a portion of the playlist is not displayed due to its referral to unauthorized content. The playlist can alternatively list out each reference of the playlist but can differentiate permissible content from impermissible content graphically. For example, references to permissible and impermissible content can be distinguished by different colors, fonts or associated graphics (i.e., differentiating active content from inactive content by any conventional manner for display on a computer monitor—e.g., by separating authorized content from unauthorized content by grouping, presentation using separate display windows, font type, font size, font color, location of presentation, etc.). Under another scenario, the entire playlist can be prevented from being displayed or accessed by a user if any portion of the playlist is linked to unauthorized content as determined by the access rights of the user.

DRM rights can be based on individual attributes as well as attributes of a user when associated with particular defined groups. Viewers of playlists can be distinguished by age or grade level. Content associated with a particular playlist can be similarly rated based on age and/or grade level so that, for example, content intended for higher grade levels can be omitted or made inactive when the playlist is presented to a user of a lower grade level. Further, the content comprising a playlist may have differing expiration dates for different user groups or individuals. Therefore, external factors such as the date, relative to a set expiration date of the underlying playlist content, can affect playlist creation/presentation.

Content that is restricted to a viewer of a playlist can be associated with a “Request Access” feature. For example, if the content is not available because a particular user does not have a license to a portion of the underlying content, then the playlist can include a feature for the user to initiate a purchase, license or other request for the underlying content that is not currently available. This request for acquisition can be made directly to the publisher of the playlist, to the owner of the underlying content or to a content administrator who makes decisions regarding which content to purchase or otherwise make available to users. If the content is restricted due to DRM rights, then the playlist can include a feature to initiate a request for a waiver to allow access to the underlying content. Waiver requests can be sent to the publisher of the playlist or to a digital access rights administrator. Requests for restricted content can be made individually for each restricted item or can be made in bulk by requesting access to all or a portion of the restricted components of a playlist.

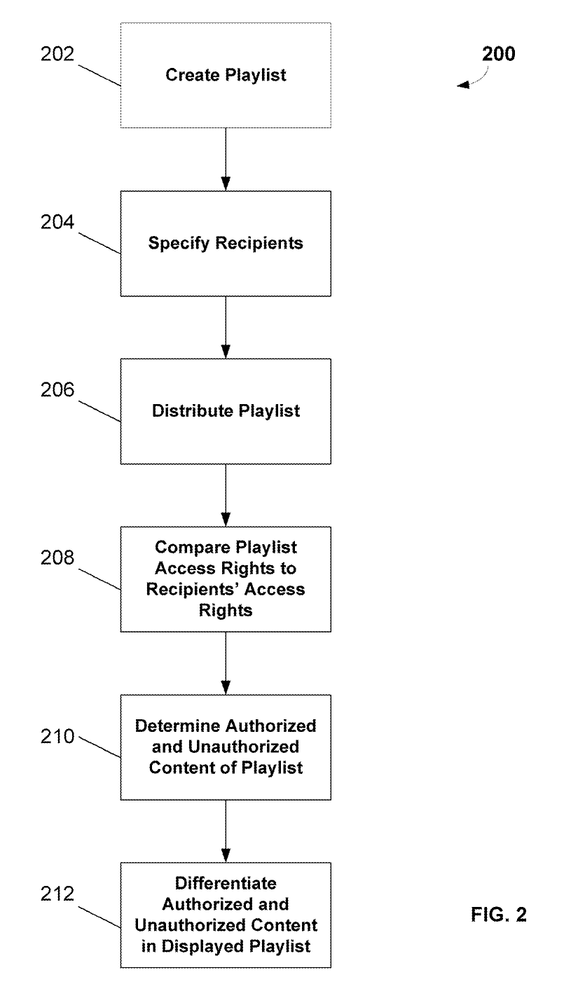

FIG. 2 illustrates a method 200 for dynamically presenting a playlist to a recipient in accordance with an aspect of the present invention. As shown in FIG. 2, a playlist is generated at step 202. The playlist can be generated by a user located remotely from one or more of the intended recipients of the playlist. The playlist can include references to portions of one or more files. The references can include links (e.g., Uniform Resource Locator-type links), database identifiers or other pointers to the portions of the selected files specified by the creator. At step 204, the creator or publisher of the generated playlist can specify the intended recipients of the playlist, attributes required for various rights permissions (e.g., minimum age requirement for access permission, job position (e.g., teacher, administrator for redistribution permission, etc.). The intended recipients can include a single recipient or multiple recipients. The intended recipients can be specified individually or collectively, for example, by specifying a group of intended recipients (e.g., all tenth grade students).

At step 206, the playlist can be distributed to the intended recipients. Distribution of the playlist can include uploading the playlist to a central server for review of the playlist in view of the intended recipient list. At step 208, the access rights of the content comprising the playlist can be obtained and compared to the access rights of each of the intended recipients. That is, a designated access level or access time frame of the underlying playlist content can be compared to the designated access level or access time frame associated or assigned to each of the desired recipients. At step 210, authorized portions of the playlist and unauthorized portions of the playlist are determined for each recipient. In particular, for each recipient, the portions of the selected content, e.g., multimedia (such as video) files, that the recipient has rights to access can be determined and categorized as authorized multimedia content. Likewise, for each recipient, the portions of the selected multimedia files to which the recipient does not have rights can be determined and categorized as unauthorized multimedia content. Accordingly, for any given intended recipient, the generated playlist can include all authorized content, all unauthorized content or a mix of authorized and unauthorized content.

At step 212, the playlist is displayed to each recipient such that each reference to authorized content is distinguished from each reference to unauthorized content. That is, references to authorized content can be visually differentiated from references to unauthorized content. As mentioned above, any means for visually or graphically distinguishing a first group of related items from a second group of related items can be used to differentiate authorized content from unauthorized content. For example, references to authorized content can be displayed as active links to the underlying referenced content while references to unauthorized content can be displayed as inactive links to the underlying referenced content.

Also at step 212, one or more options for requesting access to the unauthorized content can be provided to each recipient of the playlist. The option for requesting access can comprise requesting a license for the unauthorized content, requesting the purchase of the unauthorized content or requesting a waiver to access the unauthorized content on perhaps a limited basis. The option for requesting access can also comprise a request to a central access rights administrator having authority to grant access to unauthorized content. The option for requesting access can be provided on an individual or collective basis for each reference that refers to unauthorized content. That is, a recipient can request access to any content designated as unauthorized by requesting access to each content separately, by requesting access to all such content collectively or by requesting access to some subset of the entire group of unauthorized content.

Search results can also be dynamically provided to a user in a manner similar to the dynamic presentation of playlists discussed above. That is, search results displayed to a user can be presented in a way to distinguish authorized content from unauthorized content. For example, a user may specify a query for searching data such as a database, a repository of content, etc. Based on the query, data or content satisfying the query can be determined. The access rights of the data or content satisfying the query can then be compared to the access rights of the user conducting the search. Based on the comparison, references to authorized data or content and references to unauthorized data or content can be determined. The references to the authorized data or content can then be displayed in a manner to distinguish them from reference to the unauthorized data or content as described above. Further, the search results can be provided with options for the user to request access to the unauthorized data content. Such a request can trigger a message to an approval authority to grant or deny the requested access. The authority can send such approval or denial to the search system, which can then inform the user of the result and grant or deny access in accordance with the message from the authority. The request can trigger an opportunity to purchase a license to the data or content. The license can, for example, grant the right to access only, access and redistribute only, redistribute only, etc. Different prices and conditions can be associated with different licenses and with different requesters. For example, a student user may be granted access only at no or reduced cost, while a non-student user may be granted access at a higher price, or else denied access. The system in accordance with the present invention can collect any appropriate fee from the user and grant the license. Additionally, the access rights assigned to the user conducting the search can be used to filter the results of the search. That is, the query specified by the user can be applied to only data or content stored in the repository to which the user has rights. Such rights can include, without limitation, access rights, redistribution rights, derivative work rights, copying rights, rendering rights, etc. A user may also have search rights that can be compared with permissions associated with an item. Search rights for an item indicate the user's authorization to have a reference to that item returned as a result of a search. Search rights need not be exclusive of other rights. For example, a user may have the right to access a given data or content item, type of item, or items having a given attribute or attributes, but not have the right for a reference to that item returned as a result of a search. An embodiment of the present invention can facilitate the establishment and enforcement of such search rights. For example, the system can manage a request for search rights to a given item, type of item or items having a given attribute or attributes. For example, a student user may not have search rights to educational material pertaining to human anatomy, but may request such rights. The request can be approved or denied by a teacher. If approved, the system can return references to data or content about human anatomy in response to queries from the authorized student user.

As used herein, “item” means any piece of information, including, but not limited to, content as defined above, a data element or a record in a database, etc.

During creation or publication of an item (e.g., data or content, including a video file, a portion of an audio file, a playlist comprising references to one or more data or content elements or files or portions thereof), an aspect of the present invention can alter distribution of the item and/or provide feedback or information to the creator or publisher regarding the digital access rights of users who may receive or are intended recipients of the item. For example, during assembly or publication of a playlist, the DRM rights of possible recipients of the playlist can be examined and compared to the access rights associated with the underlying items referenced in the playlist. The possible recipients can be designated by the item authorizer (such as its creator) during or immediately prior to production of the item, or in response to a request to access the item. The possible recipients can comprise a global recipient list or portion thereof, or may be subsequently identified prior to a later publication of the item. If any intended recipient or group of recipients does not have access to any content comprising the item (e.g., due to a lack of DRM rights or because the content is physically not available), then the user can be prompted for action or instructions. Alternatively, automatic action, in accordance with previous designations made by the user or content administrator, can be taken if any portion of the item is restricted to any recipient.

When the creator or publisher of an item learns that a recipient will not be able to access all or a portion of an item due to a conflict between the rights assigned to the recipient and the rights assigned to the item, then the creator can be presented with several possible actions for resolving or handling the conflict. For example, the creator can chose to instruct the system not to provide any rights to the item to the user, to grant certain rights specified by the creator or publisher, etc. The creator or publisher can indicate that only certain portions of an item be made accessible to a user. A playlist creator or publisher can specify the manner in which accessible content is to be displayed relative to inactive/inaccessible content. For example, certain items on the playlist may be designated for high resolution display in their entirety, while other items may be designated for partial low resolution display with an option to purchase rights to the entire work in high quality. Likewise, a playlist authority may designate how references to unauthorized content will be handled. The creator or publisher can elect to publish the playlist in its entirety, regardless of the rights of recipients and allow the DRM administrator to handle presentation/display of the playlist containing restricted content, as well as regulate access to the content referenced by the playlist.

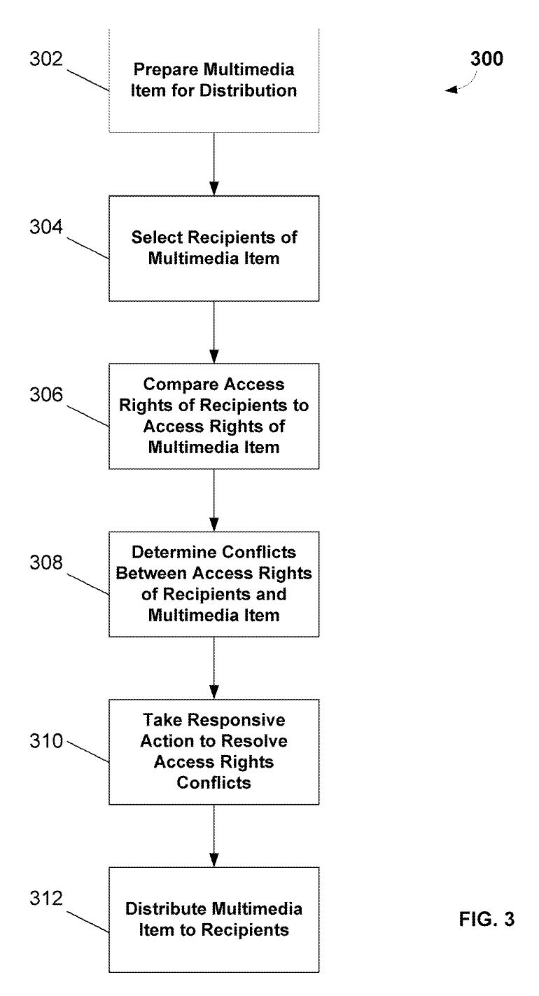

FIG. 3 illustrates a method 300 for distributing an item in accordance with an aspect of the present invention. At step 302, the item is prepared for distribution. Preparation of the item can include generating one or more pieces of data in a data base or files or other form of content, selecting one or more previously generated and stored such data or files or other form of content, or generating or selecting one or more playlists that comprises one or more references to items or any portions thereof. At step 304, the recipients of the item are selected by the publisher or creator of the item. Alternatively, at least some users can request the item, e.g., after viewing the results of a search.

At step 306, the access rights assigned to the item are compared to the access rights assigned to each intended recipient of the item. For playlists, either the access rights of the playlist or the access rights of each individual item referred to by the playlist can be compared to the access rights of the recipients. Playlist can be designated to inherit either the most restrictive or the least restrictive access rights of any item that is a component of the playlist.

At step 308, conflicts between the access rights of the item and the access rights of each recipient are determined. A conflict between the access rights of the item and the access rights of each recipient can occur if the access level of the content is more restrictive than the access level or range of access associated with a particular recipient. Conflicts can also arise if the content is associated with an expiration date that prevents a recipient from access the content. Further, a conflict can occur if a license or waiver to the content, or if the purchase of the item, is necessary prior to approving access. The conflicts determined in step 308 can be presented to the publisher or other authorizing entity of the item. For example, the conflicts for each individual recipient or for related groups of recipients can be presented to the publisher or other authorizer.

At step 310, the creator of the item can be prompted or provided with one or more options for handling or resolving the conflicts determined in step 308. For example, the user can elect not to distribute the item at all or to distribute only authorized portions of the item to the recipients. The user can alternatively choose to distribute the item such that authorized portions of the item are presented in manner to distinguish them from the unauthorized portions of the item. Further, the user can preemptively request a license or waiver to the unauthorized portions of the item (or otherwise request access to the unauthorized content from a central administrator on behalf of a recipient) for each recipient that does not have full access to the item. Any selected options provided to the user at step 310 can be automatically implemented in accordance with an aspect of the present invention based on predefined preferences specified by the publisher, creator or other authorizer of the item. In this way, items can be distributed more quickly and efficiently without requiring the user to resolve each access rights conflict for each recipient or group of recipients.

At step 312, the item is distributed or delivered to each intended recipients in accordance with the actions taken in step 310 to resolve access rights conflicts.

While various embodiments of the present invention have been described above, it should be understood that they have been presented by way of example and not limitation. It will be apparent to one skilled in the pertinent art that various changes in form and detail can be made therein without departing from the spirit and scope of the invention.

The present invention can provide central distribution and management capabilities that are applicable to a wide variety of network architectures and content delivery schemes. That is, the present invention is applicable to network architectures comprising wireless, satellite, optical, or cable (coaxial cable, telephone twisted pair, power lines, etc.) links (or any combination thereof). Further, the present invention is applicable to the distribution of any type of information between network components including video, data, audio or voice files or segments (or any combination thereof), as well as data residing in a database.

The present invention can be implemented in software, hardware or any combination thereof. The software can comprise a set of instructions executable on one or more processors within a central server. The software can implement the distribution and management of information and each of the related features described herein.

What is claimed is:

1. A method for dynamically presenting to a user a playlist containing a plurality of references to items, comprising:
comparing access rights assigned to an item that is referenced by the playlist, to access rights of the user;
based on the comparison determining if an item is authorized or unauthorized to the user; and
displaying the playlist to the user in a manner than indicates whether an item is authorized or unauthorized.

2. The method of claim 1, wherein displaying further comprises displaying the reference to the authorized item as an active link.

3. The method of claim 2, wherein displaying further comprises displaying the reference to the unauthorized item as an inactive link.

4. The method of claim 3, wherein displaying further comprises providing the user with an option to request access to the unauthorized item.

5. The method of claim 4, wherein the option to request access comprises requesting a license to the unauthorized item.

6. The method of claim 4, wherein the option to request access comprises requesting an administrator to grant access to the unauthorized item.

7. The method of claim 2, wherein displaying further comprises not displaying the reference to the unauthorized item.

8. The method of claim 7, wherein displaying further comprising providing the user with an option to request access to view the reference to the unauthorized item.

9. A method for distributing a playlist, comprising:
identifying a playlist for distribution;
selecting a recipient to receive the playlist;
comparing access rights assigned to the playlist to access rights of the recipient;
based on the comparison detecting a conflict between the access rights assigned to the playlist and the access rights of the recipient;
determining a responsive action to resolve the conflict.

10. The method of claim 9, wherein the access rights of the playlist are determined based upon the access rights assigned to items referenced by the playlist.

11. The method of claim 9, wherein the access rights of the playlist are assigned to the playlist itself.

12. The method of claim 9, further including performing a responsive action including not sending the playlist.

13. The method of claim 9, further including performing a responsive action including sending a request to an administrator to grant sufficient access rights to the recipient to resolve the conflict.

14. The method of claim 9, further including performing a responsive action including sending the playlist.

15. A method of dynamically presenting search results to a user, comprising:
receiving a query;
searching a repository of items to identify an item satisfying the query;
comparing access rights assigned to the item satisfying the query to access rights of the user;
based on the comparison determining if an item satisfying the query is authorized or unauthorized; and
displaying references to the items satisfying the query in a manner than indicates whether an item is authorized or unauthorized.

16. The method of claim 15, wherein displaying further comprises displaying the reference to the authorized item as an active link.

17. The method of claim 15, wherein displaying further comprises displaying the reference to the unauthorized item as an inactive link.

18. The method of claim 17, wherein displaying further comprises providing the user with an option to request access to the unauthorized item.

19. The method of claim 18, wherein the option to request access comprises requesting a license to the unauthorized item.

20. The method of claim 18, wherein the option to request access comprises requesting an administrator to grant access to the unauthorized item.

21. The method of claim 15, wherein displaying further comprises not displaying the reference to the unauthorized item.

22. The method of claim 21, wherein displaying further comprising providing the user with an option to request access to view the reference to the unauthorized item.

23. A method for centrally administering distribution and access to an item between a central server and a remote location, comprising:
assigning access rights to the item; and
scheduling distribution of the item upon receipt of a request from an authorized remote location according to bandwidth capabilities of a communication link connecting the authorized remote location to the central server.

24. The method of claim 23, further comprising creating the item at a second remote location.

25. The method of claim 24, further comprising uploading the item to the central server from the second remote location.

26. The method of claim 24, further comprising the creator of the item assigning original access rights to the item.

27. The method of claim 26, wherein assigning further comprises overriding the original access rights assigned to the item.

28. The method of claim 23, wherein assigning further comprises assigning the item an expiration date.

29. The method of claim 23, wherein assigning further comprises assigning the item an access level.

30. The method of claim 23, wherein scheduling further comprises confirming the authorized remote location is approved to receive the item.

31. The method of claim 23, wherein scheduling further comprises transmitting the item to the authorized remote location substantially immediately after receiving the request.

32. The method of claim 23, wherein scheduling further comprises transmitting the item to the authorized remote location during off-peak hours of the communication link.
